(19) United States
(12) Patent Application Publication
(10) Pub. No.: US 2026/0306995 A1
(43) Pub. Date: Oct. 8, 2026

(54) PROCESSES FOR SORBENT REGENERATION

(71) Applicant: SHELL USA, INC., Houston, TX (US)

(72) Inventors: Sayee Prasaad BALAJI, Amsterdam (NL); Timothy Michael NISBET, Amsterdam (NL); Charles Duncan BRODIE, Boston, MA (US); Thao Nguyen, Boston, MA (US); Muthu Mailvaganan Anandhan, Boston, MA (US)

(21) Appl. No.: 19/482,840

(22) PCT Filed: May 1, 2024
(86) PCT No.: PCT/EP2024/061985

§ 371 Date: Nov. 10, 2025

(30) Foreign Application Priority Data
May 11, 2023 (EP) 23172715.7

(51) Int. Cl. B01D 53/04; B01J 20/34

(52) U.S. Cl. CPC B01D 53/0462; B01D 53/0438; B01D 53/0446; B01J 20/3466; B01D 2257/504; B01D 2259/4009

(57) ABSTRACT

A method for operating regeneration cycles of a sorbent housing array includes starting a regeneration cycle for a first group of sorbent housing apparatus(es) in the array at time T_{S1}, starting a regeneration cycle for a second group of sorbent housing apparatus(es) in the array at time T_{S2}, starting a regeneration cycle for applicable remaining groups of sorbent housing apparatuses in the array. Each group has its own respective start time (T_{Si}) at which the respective regeneration cycle is started, where the start time, T_{Si}, for each of the groups in the array is not the same as one another. The method further includes sequentially performing regeneration of sorbent in the respective sorbent housing modules of the sorbent housing apparatus(es) in each group to complete the respective regeneration cycle and providing the desorbed streams from all sorbent housing apparatuses of the array to a processing equipment.

### FIELD OF THE INVENTION

The present specification generally relates to the field of gas capture, and more specifically, to sorbent regeneration.

### BACKGROUND OF THE INVENTION

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of any prior art.

Many conventional gas capture processes employ sorbents, such as adsorbent beds, that preferentially adsorb at least one component of a feed gas mixture to separate it from the remaining feed gas components, thereby generating loaded sorbents. The loaded sorbents are then subsequently regenerated to desorb the adsorbed component and allow for cyclic reuse of the sorbent.

One particular application for gas capture processes is the direct air capture process (DAC). Direct air capture of carbon dioxide from the air has been proposed as one way of addressing human induced climate change. Current estimates place global levels of CO2 in the atmosphere at around 420 parts per million. This is expected to rise to around 900 parts per million by the end of the 21st century. Hence, DAC represents one of a range of technologies that can be employed to reduce the environmental impact of greenhouse gases like CO2 and help the transition to a low carbon global economy.

Typical DAC systems take large quantities of air (or other conditioned gaseous atmosphere) which is pumped as a feed stream through a unit that contains a sorbent substance that removes the CO₂ from the stream under ambient conditions. Over time the sorbent becomes loaded with captured CO₂. Next, the captured CO₂ in the sorbent is extracted from the sorbent in a regeneration/desorption step. Desorption may involve thermal or chemical processes depending upon the type of sorbent material that is selected for use in the DAC.

Desorption typically uses steam as a heating and stripping medium. The desorbed stream is typically passed to downstream equipment, such as a cooler and compressor, which can service multiple DAC modules. Over the course of an adsorption/desorption cycle, the flow, temperature and composition of the desorbed stream vary with time. The variations in the condition of the desorbed stream in conjunction with having to handle multiple desorbed streams can introduce challenges to the downstream equipment in handling the fluctuating flow, temperature and composition.

Although certain prior art references have disclosed various timing for the adsorption and regeneration cycle for individual beds in an adsorber device, these disclosures fail to address the impact of fluctuations in the conditions of desorbed streams from multiple adsorber devices, i.e., an array of adsorber devices.

For instance, U.S. Pat. No. 9,308,486 discloses a sequence for individual beds in a single structured adsorbing unit comprising N adsorbing beds, where N is greater than or equal to 3. Each bed is subjected to a sequence comprising, in succession, an adsorption cycle, and a regeneration cycle.

Similarly, EP1382375 discloses a process comprising at least three parallel thermal swing adsorption zones, wherein the adsorption cycles are phased so that the number of zones in the adsorption step is greater than the number of zones not in the adsorption step.

### SUMMARY OF THE INVENTION

According to one aspect, there is provided a method for operating regeneration cycles of a sorbent housing array that comprises two or more sorbent housing apparatuses. Each housing apparatus comprises two or more sorbent housing modules, and each housing module configured to hold a sorbent to capture a gas from a gas mixture. The sorbent housing modules of each respective sorbent housing apparatus are coupled to one another for sequential regeneration by a regenerating unit in a regeneration cycle. The method comprises (a) starting a regeneration cycle for a first group of sorbent housing apparatuses at time T_{S1}, where the first group comprises at least one sorbent housing apparatus; (b) starting a regeneration cycle for a second group of sorbent housing apparatuses at time T_{S2}, where the second group comprises at least one sorbent housing apparatus; (c) starting a regeneration cycle for applicable remaining groups of sorbent housing apparatuses in the array, where each group has its own respective start time (T_{Si}) at which the respective regeneration cycle is started, where the start time, T_{Si}, for each of the groups in the array is not the same as one another; (d) sequentially performing regeneration of the sorbent in the respective sorbent housing modules of the sorbent housing apparatus(es) (102a) in each group to complete the respective regeneration cycle, where performing the regenerating cycle generates a desorbed stream from each respective sorbent housing apparatus; and (e) providing the desorbed streams from all sorbent housing apparatuses of the array to a processing equipment.

Optionally, in an embodiment, the start time, T_{Si}, of the groups of sorbent housing apparatuses can be offset from one another by a set period of time. Optionally, the set period of time is an array lag time, T_{ARRAY}, as expressed in equation (A)

$${T}_{S ( i + 1 )} = {T}_{Si} + {T}_{ARRAY} \qquad ( A )$$

wherein T_{ARRAY} is calculated according to equation (B)

$${T}_{ARRAY} = z * {T}_{Raverage} / ( total number of sorbent housing modules in the array )$$

where z is an average of the number of sorbent housing apparatus(es) across the groups in the array, as depicted in equation (C)

$$z = ( total number of sorbent housing apparatuses in the array ) / ( total number of groups in the array ) \qquad ( C )$$

$$where {T}_{Raverage} = ( sum of all regeneration cycle time s , {T}_{Ri} ) / ( total number of apparatuses in the array )$$

wherein T_{Ri} being the time to complete the regeneration cycle for each sorbent housing apparatus being a regeneration cycle time for the respective sorbent housing apparatus.

Optionally, in an embodiment, the regeneration cycle time for all the sorbent housing apparatuses in the sorbent array are equal.

Optionally, in an embodiment, the groups of sorbent housing apparatuses comprise two or more apparatuses.

Optionally, in an embodiment, the further processing equipment comprises equipment to perform at least one of a cooling step, a condensation step, a compression step, a drying step.

Optionally, in an embodiment, the sorbent is selected from the group consisting of monolithic sorbent, extrudates, tablets, foams, sheets.

Optionally, in an embodiment, the selected gas is carbon dioxide. Optionally, in an embodiment, the gas mixture is ambient air.

Optionally, in an embodiment, the method can further comprise continuously performing steps (a)-(e) to regenerate all the sorbent in the array for applicable regeneration cycles.

The present disclosure provides embodiments that reduce variations in flow of the desorbed streams, which improves the overall regeneration operations because less adjustments are needed downstream as a result of less fluctuations. Reduced variations of flow and less adjustments can result in a more effective seal during regeneration.

### BRIEF DESCRIPTION OF THE DRAWINGS

FIG. 1 illustratively depicts an array comprising two or more sorbent housing apparatuses according to certain aspects described herein.

FIG. 2 illustratively depicts the array of FIG. 1, along with respective regeneration start time, T_{Si}, and end time, T_{Ei}, according to certain aspects described herein.

FIG. 3 illustratively depicts another array comprising two or more sorbent housing apparatuses, along with respective regeneration start time, T_{Si}, and end time, T_{Ei}, according to certain aspects described herein.

FIG. 4 depicts a graph generated from a model that shows the flow of the regeneration exit stream from the array (y-axis) over time (x-axis) for a regeneration cycle that was not conducted according to aspects described herein.

FIG. 5 depicts a graph generated from a model that shows the flow of the regeneration exit stream from the array (y-axis) over time (x-axis) for a regeneration cycle that was conducted according to certain aspects described herein.

### DETAILED DESCRIPTION OF THE INVENTION

The present invention will now be described in detail with reference to embodiments thereof as illustrated in the accompanying drawings. References to “one embodiment”, “an embodiment” “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Other suitable modifications and adaptations of the variety of conditions and parameters normally encountered in the field, and which would be apparent to those skilled in the art, are within the spirit and scope of the invention.

Although the description herein provides numerous specific details that are set forth for a thorough understanding of illustrative embodiments, it will be apparent to one skilled in the art that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

In addition, when like elements are used in one or more figures, identical reference characters will be used in each figure, and a detailed description of the element will be provided only at its first occurrence. Some features or components of the systems or processes described herein may be omitted in certain depicted configurations in the interest of clarity.

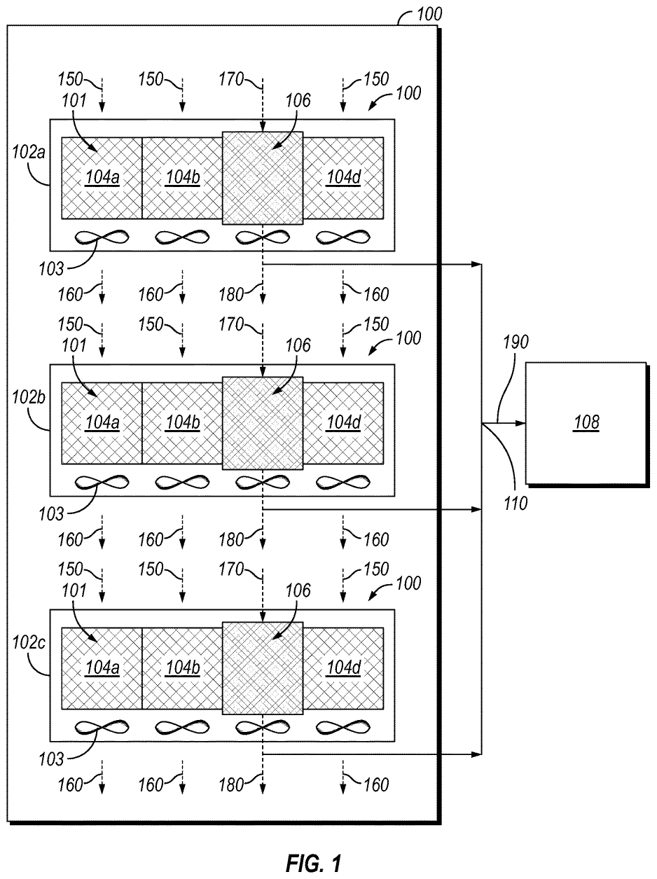

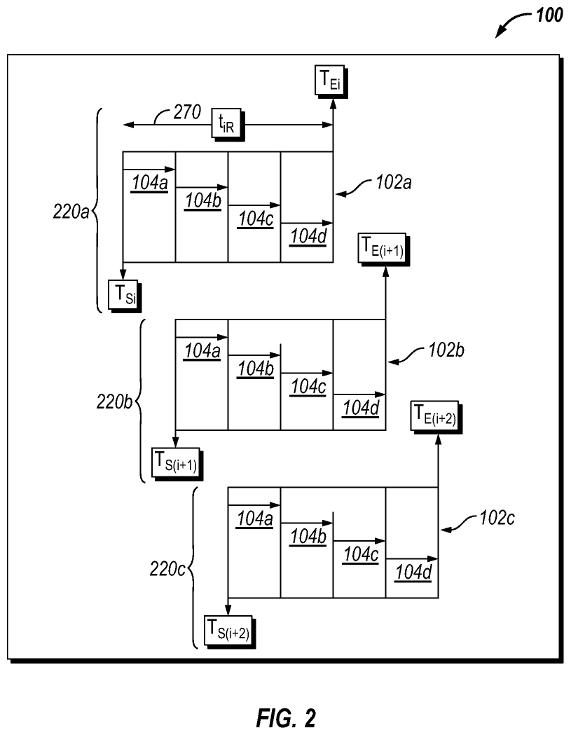

FIGS. 1 and 2 depict sorbent housing array 100, which comprises at least two sorbent housing apparatuses 102. In FIGS. 1 and 2, array 100 comprises three sorbent housing apparatuses 102a, 102b, and 102c. Each housing apparatus 102 comprises two or more sorbent housing modules 104. In FIGS. 1 and 2, each housing apparatus comprises four sorbent housing modules 104a, 104b, 104c, and 104d. Each housing module 104 is configured to hold its respective sorbent to capture a gas from a gas mixture. The sorbent is a solid sorbent configured to preferably capture carbon dioxide in a gaseous stream. Suitable examples of the sorbent can be any described in the prior art, such as comprising potassium carbonate or an amine, or other suitable sorbent materials, to capture the carbon dioxide. Suitable sorbents are described in e.g. X. Shi et al, Sorbents for the Direct Capture of CO2 from Ambient Air, Angew. Chem. Int. Ed. 2020, 59, 2-25. An embodiment of the sorbent can comprise the amine or carbonate on mesoporous alumina (e.g. α or γ-alumina) or silica honeycomb monolith substrate or other suitable materials. Other suitable examples of the sorbent are also provided in IN202341007002 and IN202341006950. The sorbent is preferably selected from the group consisting of monolithic sorbent, extrudates, tablets, foams, sheets.

The sorbent housing modules 104 of each respective sorbent housing apparatus 102 are coupled to one another for sequential regeneration by a regenerating unit 106 in a regeneration cycle 270. As will be discussed further in the present disclosure, there is a regeneration exit stream 180 provided from each sorbent housing apparatuses 102 during regeneration. The exit streams 180 of all apparatuses 102 in an array 100 are provided to further processing equipment 108.

Referring to FIG. 1, during operation, feed gas 150 comprising the selected gas is drawn through the sorbent by suitable equipment, such as impellers 103, such as fans. Typically, feed gas 150 is air but optionally, it can also comprise a conditioned gas enriched with the selected gas, such as a flue exhaust gas from an industrial or biological process if the selected gas is carbon dioxide. As the feed gas stream 150 passes across the surfaces of the sorbent, at least a portion of the selected gas reacts with the sorbent structure(s) and is captured. Adsorption exit stream 160 leaving the sorbent and its respective sorbent housing module 104 has less selected gas than the feed gas stream 150. When used in a direct-air-capture application, the adsorption exit stream 160 with less CO₂ can be vented or returned directly to the atmosphere without further processing.

When desired, such as when the sorbent has captured a certain amount of selected gas, the sorbent can be regenerated to release or desorb the captured gas so the sorbent can be used again to capture additional gas from feed gas stream 150. Each sorbent housing apparatus 102 comprises a regenerating unit 106 to regenerate the sorbent. Regenerating unit 106 is preferably configured to encompass one sorbent housing module 104 (shown as 104c) at any given time, which leaves the remaining sorbent housing modules 104a, 104b, and 104d of the respective sorbent housing apparatus open for adsorption. Regenerating unit 106 is preferably moveable to an adjacent sorbent housing module 104 to perform regeneration at a selected time. In this way, regeneration is performed in a sequential manner from one sorbent housing module 104 to another sorbent housing module 104. The cycle of adsorption and regeneration in a sorbent housing apparatus 102 can occur continuously without interruption and significant downtime. One particular example of sorbent housing apparatus 102 and regenerating unit 106 is disclosed in EP23161390.2. It will be appreciated that the configuration of a movable regenerating unit 102 depicted in FIG. 1 is merely exemplary. It is understood that other arrangements for sequential regeneration are possible, for example, U.S. Pat. No. 10,512,880 describes an arrangement whereby the sorbent modules (such as monolith beds) are moved in endless loops through a static regeneration unit. Embodiments of the methods of the present disclosure can be applied to all suitable sequential regeneration arrangements, such as those described herein and in U.S. Pat. No. 10,512,880. Other suitable sequential regeneration arrangements can include those where both the sorbent housing modules and regeneration unit are static, and valves are opened and closed to connect the sorbent housing modules to the regeneration unit, in a sequential manner as described herein.

During regeneration, the regenerating fluid stream 170 is provided to the sorbent to release the captured gas. The initial portion of regeneration exit stream 180 typically comprises mostly of the entrained feed gas 150, such as air, as the regenerating fluid stream 170 pushes the entrained feed gas 150 out of sorbent housing module 104. When this initial portion is preferably vented. Eventually, the regeneration exit stream 180 comprises mostly the regenerating fluid and the desorbed selected gas, preferably carbon dioxide. The portion of the exit stream 180 that comprises a high purity of the desorbed selected gas is desirable because the regeneration exit stream 180 can be provided to further processing equipment 108.

As can be seen in FIG. 1, the exit stream 180 of all of the sorbent housing apparatuses 102 in array 100 are provided to further processing equipment 108. Optionally and preferably, as shown in FIG. 1, all the regeneration exit streams 180 can be routed to conduit 190 to be provided to further processing equipment 108. Suitably, in larger arrays it may be desirable to first combine exit streams 180 in a series of sub-conduits and further combine these sub-conduits into a number of main conduits leading to the further processing equipment 108.

It is understood that array 100 and further processing equipment 108 are fluidly connected to allow the exit stream 180 from a regeneration cycle of all apparatuses 102 in array 100 to be provided to equipment 108 to be further processed. The illustration in FIG. 1 of the particular flow of exit streams 180 from apparatuses 102a, 102b, and 103c to equipment 108 is for illustrative purposes. One of ordinary skill can design and select the number of junctions to suitably route the output of apparatuses 102 to equipment 108. The further processing by equipment 108 includes at least one of a cooling step, a condensation step, a compression step, and a drying step. The further processing equipment 108 prepares the regeneration exit stream as a suitable feed for subsequent applications. For instance, cooling of the exit stream 180 can be desirable to limit the temperature of the process in downstream equipment 108 if subsequent applications prefer a feed with a temperature that is lower than that of the exit stream 180. Condensation can be desirable, when using steam as the regeneration fluid 170, to reduce the level of water in the exit stream 180, if subsequent applications prefer the steam in liquid form and/or a feed gas stream with lower amount of water. Subjecting the exit stream 180 to a condensation is also suitable manner to separate the carbon dioxide from the exit stream as the carbon dioxide will remain in gas form. A compression step can be desirable when a subsequent application prefers a feed stream that is operated at elevated pressure above atmospheric. Drying can be desirable when low levels of water are preferred for a feed in subsequent applications. Based on the desired further processing of exit stream 180, one of ordinary skill can select the suitable equipment to employ as further processing equipment 108.

Other references disclose cycling the adsorption and regeneration modes of the sorbent in the modules of a sorbent housing apparatus. However, they do not address how the sorbent housing apparatuses of an array should be operated with respect to one another, particularly the starting time of the regeneration cycle of the apparatuses. Surprisingly, it has been found that controlling when the regeneration cycle of the sorbent housing apparatuses 102 starts with respect to other apparatuses 102 allows for improved control of pressure [in the modules 104] during regeneration, which can improve the operations of further processing equipment 108. Generally speaking, during regeneration, the chamber of the sorbent housing module 104 holding the sorbent to be regenerated preferably should be suitably sealed for at least the duration of the regeneration process. A more effective seal tends to lead to more efficient desorption because either less desorbed gas, such as CO₂, is leaked out, thereby leading to better recovery of the desorbed gas, and/or less external air leaks into the chamber of the respective module 104, thereby leading to contamination of the regeneration exit stream comprising the desorbed gas, such as CO₂.

The methods provided herein allow for control of the flow of the exit stream from the sorbent housing array to downstream equipment in a manner that provides an array exit stream with a flow rate that has a smaller range of fluctuations than an array that is not operated according to aspects described herein. An exit stream with smaller fluctuations in the flow rate, or a smoother flow, during at least the length of regeneration, results a corresponding smaller range of pressure fluctuation in the sorbent chamber undergoing regeneration. The smaller fluctuation in pressure during regeneration is desirable because it facilitates establishing of and maintaining a more effective seal as compared to a larger fluctuation by providing a smaller range in the differential pressure across the seal, between the sorbent chamber and the feed gas stream 150. For instance, if there is a drop in the flow rate of the combined regeneration exit stream 190 being provided to further processing equipment 108, operating at a constant pressure, the pressure in the sorbent chamber of the respective module 104 drops correspondingly, which can lead to leakage of air into the chamber. One way to maintain the pressure in the chamber of the respective module 104 in a desired pressure range that provides an effective seal, such as slightly above atmospheric pressure (such as, in a range from 1.0 to 1.1 bar/100 to 110 KPa (or 14.5 to 16.0 psi)), is to increase the pressure downstream of junction 110 in the conduit providing the combined regeneration exit stream 190 to further processing equipment 108 correspondingly. This can be achieved by means known to one of ordinary skill, such as by adjusting an applicable valve downstream of junction 110 to decrease the flowrate of the combined exit stream 190 into further processing equipment 108. Or vice versa, when the flowrate of the combined exit stream 190 fluctuates suddenly upward, the pressure in the system, particularly in the sorbent chamber and in further processing equipment 108, increases correspondingly, which can lead to leakage of desorbed gas out of the chamber. One way to accommodate such flow and pressure fluctuation and maintain the pressure in the sorbent chamber in the desired range is to decrease the pressure downstream of junction 110 in the conduit providing the combined regeneration exit stream 190 to further processing equipment 108. The methods described herein allow for control of, particularly minimizing, the fluctuation in the flowrate of the combined exit stream 190, which leads to control of, particularly minimizing, the fluctuation in the pressure experienced by further processing equipment 108, and hence minimizing the amount of corresponding adjustment of downstream pressure to accommodate such changes to maintain the desired pressure range in the sorbent chamber of the respective module 104.

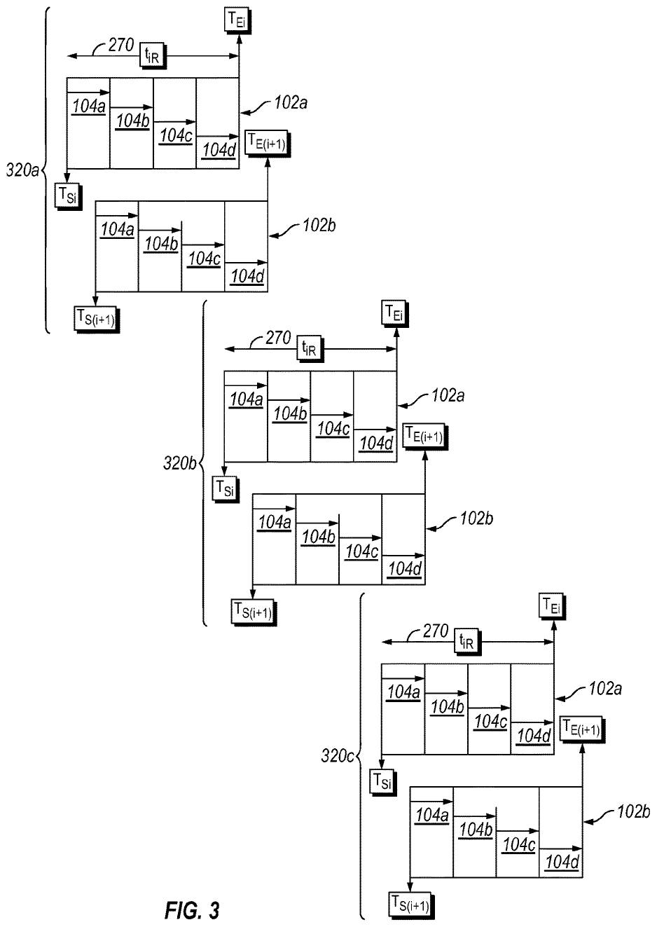

According to one aspect, the present disclosure provides a method for operating regeneration cycles of sorbent array 100. Referring to FIGS. 2 and 3, the sorbent housing apparatuses 102 can be organized into groups 220, where each group 220 comprises at least one or more sorbent housing apparatuses 102. For instance, in FIG. 2, array 100 comprises three groups 220a, 220b, and 220c. Each group 220 comprises one sorbent housing apparatus 102, specifically group 220a comprises apparatus 102a, group 220b comprises apparatus 102b, and group 220c comprises apparatus 102c. In FIG. 3, array 100 comprises three groups 330a, 330b, and 330c. Each group 330 comprises two sorbent housing apparatuses 102, specifically, group 320 a comprises apparatuses 102a and 102b, group 320b comprises apparatuses 102c and 102d, and group 320c comprises apparatuses 102e and 102f.

Referring to FIGS. 2 and 3, the method comprises starting a regeneration cycle for a first group (such as 220a or 320a) of sorbent housing apparatuses 102 at time T_{Si}, and starting a regeneration cycle for a second group (such as 220b or 320b) at time T_{S2}. If the array, such as array 100, has additional groups of sorbent housing apparatuses remaining that need regeneration, then the method can further comprise starting a regeneration cycle for applicable remaining groups (such as 220c or 320c), where each of the applicable remaining group has its own respective time, T_{Si} at which the respective regeneration cycle is started. For instance, group 220c or group 320c has a regeneration start time of T_{S3}, and so on if array 100 would have more than three groups. The start time, T_{Si}, for each of the groups in the array is not the same as one another. That is, each group (such as 220 or 320) of sorbent housing apparatuses 102 do not start its regeneration cycle at the same time. Once a regeneration cycle for a group 220 or 320 has started, the regeneration process is sequentially performed by regenerator 106 of the respective apparatus 102 for the sorbent housing modules 104 in each sorbent housing apparatus 102 of that group. For instance, referring to FIGS. 2 and 3, the horizontal arrow in each group indicates regeneration of the sorbent for that respective sorbent housing module 104 where the regenerator 106 moves sequentially from one module to an adjacent one (e.g., 104a, then 104b, then 104c, then 104d) until the end of the regeneration cycle 270 at time T_{Ei}. If a group has more than one apparatus 102, it is preferred that the apparatuses of that group have the same regeneration cycle time, T_{Ri}. Additionally, it is also preferred that the apparatuses 102 across the groups (that is, all apparatuses 102 in array 100) have the same regeneration cycle time, T_{Ri}. It is understood, however, that the principles described herein also apply when the apparatuses have different regeneration cycle time T_{Ri} within a group and/or within the array. It is also understood that the principles described herein also apply to other suitable order in which the modules 104 of an apparatus 102 are regenerated, including whether the regenerator 106 moves from one module 104 to another module 104 and/or the modules themselves sequentially move through the regenerator 106. If a group comprises more than one apparatus 102, such as group 320 in FIG. 3, all the apparatuses 102 in that group has the same start time, T_{Si}, at which the regeneration begins and continues sequentially as described herein.

Once a sorbent in a module 104 is regenerated, it is ready for an adsorption cycle, after which, it can be regenerated in due time. Generally speaking, and as depicted in FIGS. 2 and 3, a regeneration cycle 270 is the time it takes to regenerate the sorbent in the modules 104 of a sorbent housing apparatus 102. The methods described herein reduce the fluctuations of the flowrate of the overall regeneration exit feed stream of array 100 that is provided via one conduit 190 as shown, or multiple conduits 190 (not shown) as noted herein, to further processing equipment 108. According to one aspect, the embodiments described herein achieve such reduced fluctuations at least by controlling of the start time of the regeneration cycle of the groups of apparatuses 102 in the array 100, with respect to each other. In particular, embodiments of the methods of the present disclosure provides each group of apparatuses 102 with a start time, T_{Si}, that is different from one another. Because the groups of apparatuses 102 do not start its respective regeneration cycle at the same time, the various regeneration cycles being performed by the groups of apparatuses 102 in array 100 are staggered, which spreads out the rate of the various exit streams 180 entering conduit 190. This in turn provides the feed stream flowing through conduit 190 to equipment 108 with a flow rate that has a smaller range of fluctuation. In contrast, if all the apparatuses 102 in array 100 have the same regeneration start time, T_{Si}, then all the exit streams 180 from each apparatus 102 would be provided to equipment 108 at once and stops at once (assuming the apparatuses 102 have the same regeneration cycle time 270), which would result in a larger range of fluctuations in the flow rate of the feed stream going to equipment 108 than if the start times are staggered according to the embodiments described herein.

Optionally and preferably, the start time, T_{Si}, of the groups of sorbent housing apparatuses is offset from one another by an array lag time, T_{ARRAY}, as expressed in equation (A)

$${T}_{S ( i + 1 )} = {T}_{S i} + {T}_{ARRAY} \qquad ( A )$$

wherein T_{ARRAY} is calculated according to equation (B)

$${T}_{ARRAY} = z * {T}_{Raverage} / ( total number of sorbent housing modules in the array ) \qquad ( B )$$

where z is an average of the number of sorbent housing apparatus(es) across the groups in the array, as depicted in equation (C)

$$z = ( total number of sorbent housing apparatuses in the array ) / ( total number of groups in the array ) \qquad ( C )$$

$$where {T}_{Raverage} = ( sum of all regeneration cycle time s , {T}_{Ri} ) / ( total number of apparatuses in the array )$$

In a preferred embodiment where the regeneration cycle time for the sorbent housing apparatuses 102 in array 100 is the same, the regeneration cycle of an apparatus 102 is the same as the average regeneration cycle (T_{Ri}=T_{Raverage}). For the sake of simplicity, FIGS. 1 and 2 depict three apparatuses in array 100, which means the multiplier z can be 1, allowing for there to be three different regeneration start times, one for each apparatus. Here for example, if the regeneration cycle time T_{Ri} is, for example, 60 minutes for each apparatus 102 (meaning T_{Ri}=T_{Raverage}, where it takes 60 minutes to regenerate all the modules (104a-104d) in a particular apparatus 102), z=1, and the total number of sorbent housing modules in array 100 is calculated by multiplying the number of sorbent housing modules 104 in an apparatus 102 by the number of apparatuses in array 100. For array 100 of FIGS. 1 and 2, the array lag time is 5 minutes: T_{ARRAY}=1*60/(3*4)=5 minutes. This means that if group 220a has a regeneration start time of T_{S1}, then the next group to start (such as 220b in FIG. 2) has a regeneration start time of T_{S2}=T_{S1}+5 minutes, and the group subsequent group has a regeneration start time of T_{S3}=T_{S2}+5 minutes, and so on for remaining groups in the array.

In commercial applications, however, the number of apparatuses 102 in an array 100 can be at least 10, at least 20, or even in the hundreds, such as at least 100, at least 200, at least 300. In such instances, such as when there are 20 apparatuses 102 in an array 100, although having a multiplier of 1 where each apparatus has its own regeneration start time may provide a smaller fluctuation in flowrate of the combined exit stream 180, it may be preferable to provide two apparatuses with the same regeneration start time (T_{iS}), meaning two apparatuses 102 start their regeneration cycle at the same time for a larger yet still manageable fluctuation on the system. The multiplier z in this embodiment would be 2, as it corresponds to the number of apparatuses in the array with the same start time (T_{iS}). In this embodiment, the regeneration start time of the 20 apparatuses 102 would be spread across 10 different start times (T_{iS}, . . . . T_{(i+9)S}), each staggered by an array lag time (T_{ARRAY}).

It is understood that the principles described herein apply to an array 100 of any number of apparatuses 102 whereby any suitable number of apparatuses can share the same regeneration start time, such as z=3, 4, 5, 6, 7, 8, or higher, particularly when the number of apparatuses 102 in an array 100 are in the hundreds. For example, for an array of 100 apparatuses (i.e., N=100), with each apparatus comprising 6 sorbent housing modules, then it may be desirable to have groups of five apparatuses to have the same start time, T_{iS}, which provides z=5. If T_{Ri} is 60 minutes as described in the scenario above, then T_{ARRAY} is 0.5 minutes=5*60/(100*6), where every 0.5 minutes a group of 5 apparatuses start a regeneration cycle. In other words, there would be 20 groups of five apparatuses and 20 different start times, T_{iS}, each start time spaced apart by 30 seconds.

As an example, array 100 in FIG. 3 has twice the number of apparatuses 102 as the array 100 in FIG. 2. If desired, two apparatuses 102 can be grouped together to have the same regeneration start time so that there are still three groups of apparatuses, despite doubling the number of apparatuses to the array. Such grouping maintains the array lag time at 5 minutes where z=2, and T_{ARRAY}=2*60/(6*4)=5 minutes. Alternatively, if the apparatuses are not grouped together, the array would have six different regeneration start times, and the array lag time in such scenario would be 2.5 minutes: z=1 and T_{ARRAY}=1*60/(6*4)=2.5 minutes.

In an embodiment where the array has three groups of apparatuses, the first group has two apparatuses, the second group has two apparatuses, and the third group has three apparatuses, then z would be 2.333, which is the average number of apparatuses amongst the groups in the array. If T_{Ri} is the same for all apparatuses, being 60 minutes, and there are four modules in each apparatus, then T_{ARRAY} is 5 minutes=2.333*60/(7*4), where every 5 minutes a group starts a regeneration cycle.

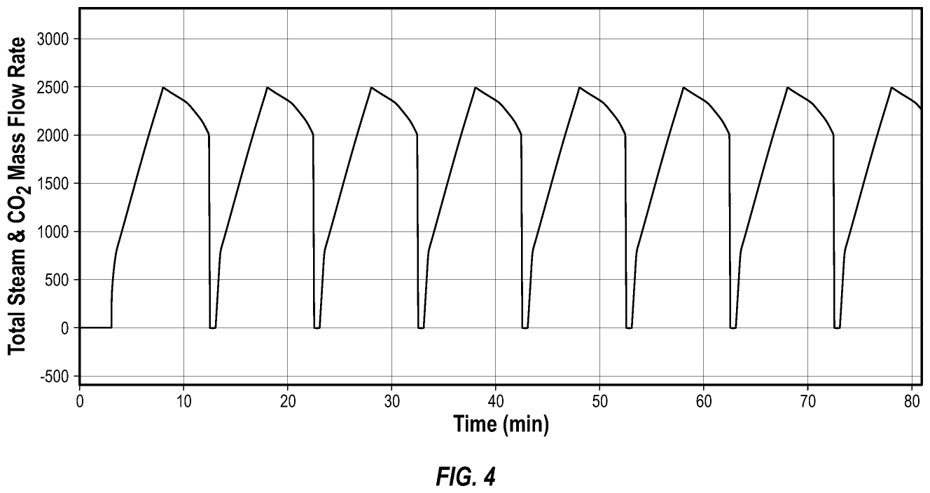

FIG. 4 is a graph generated from a model that shows the flow of the combined regeneration exit stream (e.g., 190) from all apparatuses (y-axis) in a sorbent array over time (x-axis). The sorbent array comprises 8 sorbent housing apparatuses 102, each comprising 6 sorbent housing modules 104. Each group has one sorbent housing apparatus for a total of 8 groups. The regeneration cycle time (T_{Ri}) for each sorbent housing apparatus 102 was 60 minutes and the array lag time (T_{ARRAY}) was set to zero. That is the regeneration start time for all groups were not different, but rather the regeneration cycle 270 was initiated at the same time in all 8 groups of sorbent housing apparatuses. As can be seen in FIG. 4, the flow rate of the combined exit stream varies markedly, from zero to 2500 kilograms per hour. As explained elsewhere in the present disclosure, it is more challenging to maintain an effective seal of the sorbent housing chamber when there are large fluctuations as seen in FIG. 4 because corresponding adjustments of operating parameters downstream of the chamber are usually needed to accommodate the changes in flow.

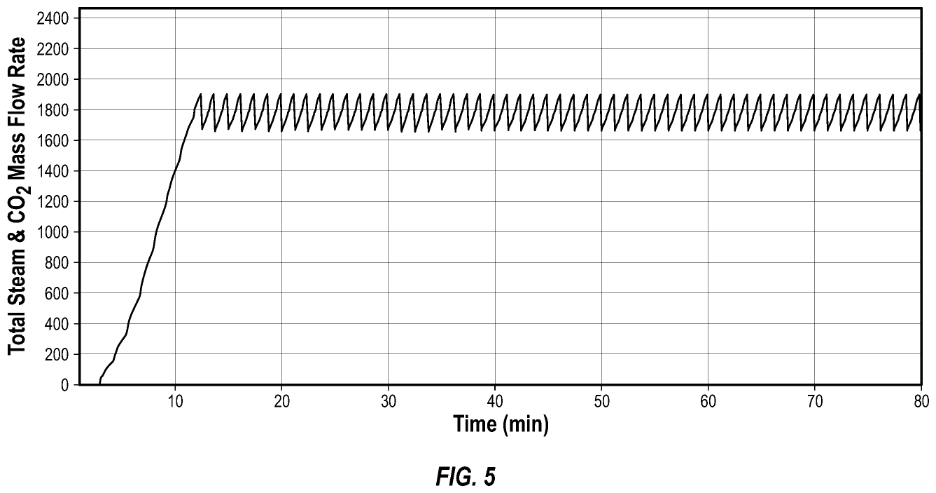

FIG. 5 is a graph generated from a model that shows the flow of the combined regeneration exit stream (e.g., 190) from all apparatuses (y-axis) in a sorbent array over time (x-axis). The sorbent array comprises 8 sorbent housing apparatuses 102, each comprising 6 sorbent housing modules 104. The regeneration cycle time (T_{Ri}) for each sorbent housing apparatus 102 was 60 minutes and the array lag time (T_{ARRAY}) was calculated as described herein, with z=1, giving T_{ARRAY}=1.25 minutes=1*60/(6*8). It can be seen that the flow rate of the combined exit stream varies only slightly in time, between about 1700 and 1900 kilograms per hour. This is a markedly more stable flow compared to the case in FIG. 4, where the array lag time was zero. In the scenario where one or more embodiments of the methods described herein are employed, the variations in flow of the combined regeneration exit stream is reduced, which means the overall regeneration operations are improved because less adjustments are needed downstream because there are less fluctuations, which results in a more effective seal during regeneration.

Optionally, to further facilitate the reduction of fluctuations in the flow rate of the overall regeneration exit stream (via 190) from the array 100 that is provided to further processing equipment 108, the method can further comprise providing a buffer volume between the sorbent housing apparatuses 102 and the point where the flow is regulated (such as a valve).

Accordingly, by staggering the start time of the regeneration cycle for the groups of sorbent housing apparatus(es) in the array, preferably staggering by an array lag time, embodiments of the method described herein can address the cumulative effect of fluctuations in the flow rate of the overall array regeneration exit stream that is provided to further processing equipment. Such steps for staggering the regeneration start time can be repeated continuously as desired as known by one of ordinary skill. The reduction of the fluctuations of the flow rate of the array regeneration exit stream allows for a more effective seal of the sorbent housing modules during regeneration. A more effective seal tends to lead to more efficient desorption as noted herein.

While not shown, it is understood that an automated control system can be used to control and/or implement some, including all, aspects of the methods described herein. For instance, the automated control system can be used to control the start time of any regeneration cycle and/or the staggering of the start time of the regeneration cycles for different groups of adsorbent apparatuses. In one embodiment the automated control system can comprise distributed control system hardware (DCS) which is programmed to send signals to all the adsorbent apparatuses in the array at the times required for them to start their regeneration cycles according to the methods described herein. In another embodiment the automated control system of each single adsorbent apparatus or group of apparatuses can comprise independent program logic controller hardware (PLC) each of which is programmed to send signals to the apparatus or group of apparatuses at the time required for it or them to start its or their regeneration cycles as according to the methods described herein. In this embodiment, the staggering of the start times of the regeneration cycles between the single or groups of apparatuses as controlled by the independent PLC's can be maintained by sending them an external reference time signal. This external reference time signal can for example be from a central, supervisory PLC or alternatively can be a time signal from a global positioning system (GPS).

While specific embodiments have been described herein, it is understood that such descriptions are not intended to limit the described embodiments. Instead, any combination of the features and elements provided above, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages described herein are merely illustrative and are not considered elements or limitations of the appended claims except where explicitly recited in a claim(s).

1. A method for operating regeneration cycles of a sorbent housing array (100), wherein the sorbent housing array comprises two or more sorbent housing apparatuses (102a, 102b, . . . ), each housing apparatus comprising two or more sorbent housing modules (104a, 104b, . . . ), each housing module configured to hold a sorbent to capture a gas from a gas mixture, wherein the sorbent housing modules (104a, 104b, . . . ) of each respective sorbent housing apparatus (102a) are coupled to one another for sequential regeneration by a regenerating unit (106) in a regeneration cycle (270), the method comprises:
a. starting a regeneration cycle for a first group (220a or 320a) of sorbent housing apparatuses (102a, 102b, . . . ) at time T_{S1}, wherein the first group comprises at least one sorbent housing apparatus (102a),
b. starting a regeneration cycle for a second group (220b or 320b) of sorbent housing apparatuses at time T_{S2}, wherein the second group (220b or 320b) comprises at least one sorbent housing apparatus (102a)
c. starting a regeneration cycle for applicable remaining groups (220c, . . . or 320c, . . . ) of sorbent housing apparatuses (102a, 102b, . . . ) in the array (100), wherein each group has its own respective start time (T_{Si}) at which the respective regeneration cycle is started;
wherein the start time, T_{Si}, for each of the groups in the array is not the same as one another;
d. sequentially performing regeneration of the sorbent in the respective sorbent housing modules (104a, 104b, . . . ) of the sorbent housing apparatus(es) (102a) in each group (220a, 222b, . . . ) to complete the respective regeneration cycle;
wherein performing the regenerating cycle generates a desorbed stream (180) from each respective sorbent housing apparatus (102a, 102b, . . . ); and
e. providing the desorbed streams from all sorbent housing apparatuses of the array to a processing equipment (108).

2. The method of claim 1 wherein the start time, T_{Si}, of the groups of sorbent housing apparatuses is offset from one another by a set period of time.

3. The method of claim 2 wherein the set period of time being an array lag time, T_{ARRAY}, as expressed in equation (A)
$${T}_{S ( i + 1 )} = {T}_{S i} + {T}_{ARRAY} \qquad ( A )$$
wherein T_{ARRAY} is calculated according to equation (B)
$${T}_{ARRAY} = z * {T}_{Raverage} / ( total number of sorbent housing modules in the array )$$
where z is an average of the number of sorbent housing apparatus(es) across the groups in the array, as depicted in equation (C)
$$z = ( total number of sorbent housing apparatuses in the array ) / ( total number of groups in the array ) \qquad ( C )$$
$$where {T}_{Raverage} = ( sum of all regeneration cycle time s , {T}_{Ri} ) / ( total number of apparatuses in the array )$$
wherein T_{Ri} being the time to complete the regeneration cycle for each sorbent housing apparatus being a regeneration cycle time for the respective sorbent housing apparatus.

4. The method of claim 3 wherein the regeneration cycle time for all the sorbent housing apparatuses in the sorbent array being equal.

5. The method of claim 1, wherein the groups of sorbent housing apparatuses comprise two or more apparatuses.

6. The method of claim 1, wherein the further processing equipment comprises equipment to perform at least one of a cooling step, a condensation step, a compression step, a drying step.

7. The method of claim 1, wherein the sorbent is selected from the group consisting of monolithic sorbent, extrudates, tablets, foams, sheets.

8. The method of claim 1, wherein the selected gas is carbon dioxide.

9. The method of claim 1, where the gas mixture is ambient air.

10. The method of claim 1, further comprising continuously performing steps (a)-(e) to regenerate all the sorbent in the array for applicable regeneration cycles.
